(19) United States
(12) Patent Application Publication
(10) Pub. No.: US 2004/0125229 A1
(43) Pub. Date: Jul. 1, 2004

(54) Image-capturing apparatus

(75) Inventors: Jun Aoyama, Sakai-Shi (JP); Shinichi Fujii, Osaka-Shi (JP); Tsutomu Honda, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/391,112

(22) Filed: Mar. 18, 2003

(30) Foreign Application Priority Data
Dec. 27, 2002 (JP) P2002-380865

(51) Int. Cl. H04N 5/232

(52) U.S. Cl. 348/345

(57) ABSTRACT

The present invention provides an image-capturing apparatus having the function of keeping on properly achieving focus on a subject while dealing with movement of the apparatus (camera), movement of the subject, and the like. When a subject moving state is detected by a panning/subject moving state detector in a full-time AF operation, an image acquiring part enlarges an AF evaluation area for obtaining image data in the direction substantially perpendicular to the ground. After that, under control of a driving controller, while driving an imaging lens forward and backward in the optical axis direction around the focus position of last time as a center, the image acquiring part acquires a plurality of pieces of image data from the AF evaluation area. A series of operations including calculation of an evaluation value regarding an in-focus state on a plurality of pieces of image data by an evaluation value calculator, determination of the next focus position by a focus position determining part, and driving to the next focus position of the imaging lens by the driving controller is repeatedly performed.

This application is based on application No. 2002-380865 filed in Japan, the contents of which are hereby incorporated by reference.

### BACKGROUND OF THE INVENTION

1. Field of the Invention

The present invention relates to a technique of controlling focus of an imaging lens in an image-capturing apparatus.

2. Description of the Background Art

A conventional digital camera performs an auto-focus (AF) operation of a so-called contrast method (hill-climbing method). For example, when a shutter start button is touched by the user, a plurality of images are obtained while moving an imaging lens in its optical axis direction, contrast values in the plurality of images are calculated and compared with each other, and the position of the imaging lens in which the contrast value becomes the highest is detected as a focus position. After that, the imaging lens moves to the focus position and focus is achieved on a subject in a focus frame. In an actual AF operation, to increase the speed of the AF operation, generally, a peak position is obtained by approximating contrast values obtained at several points near the focus position to a curve.

Some digital cameras in these days have a “full-time AF” function of always achieving focus on a subject in a focus frame even when the user does not touch a shutter start button. By the function, the user can easily recognize the composition of a picture to be taken while displaying a subject in an in-focus state on a display or the like, and an in-focus state can be realized in shorter time than a method of starting achieving focus when the user touches the shutter start button. Therefore, the AF operation easy to perform for the user can be realized by the full-time AF function.

As a technique regarding the full-time AF function, for example, a technique is proposed in which, in order to deal with occurrence of movement of the camera or the like, after an imaging lens is moved to a focus position by the AF operation of the contrast-method, a contrast value is calculated again in the position of the imaging lens, a differential value between the contrast value and a contrast value which is obtained last time in the same position of the imaging lens is computed, and the following AF operation is selected and switched according to the differential value (e.g., Japanese Patent Application Laid-Open No. 2000-47094).

However, there are problems such that an approximation curve based on contrast values obtained at several points near the focus position in the AF operation is vulnerable to distortion due to movement of the camera, movement of the subject, and the like, and a sufficient peak of an approximate curve cannot be detected so that the imaging lens is easily deviated from a proper focus position on the subject.

### SUMMARY OF THE INVENTION

The present invention is directed to an image-capturing apparatus.

According to the present invention, an image-capturing apparatus comprises: an image sensor for capturing an image through a lens and generating image data; a display for sequentially displaying a plurality of objective images based on a plurality of objective image data generated by the image sensor; a calculator for calculating an evaluation value of each objective image data as a function of evaluation image data corresponding to a predetermined area defined on each objective image; a driver for driving the lens to a focus position on the basis of a plurality of evaluation values calculated by the calculator; a moving body detector for detecting whether a subject is a moving body or not on the basis of image data generated for displaying an image of the subject on the display; and a controller, when the moving body detector detects that the subject is a moving body, for performing control of the image-capturing apparatus so as to change the size of the predetermined area and to repeatedly enable the calculator and driver.

When the subject is a moving body, the size of a predetermined area to be subjected to calculation of an evaluation value provided for each objective images obtained by image-capturing is changed by, for example, being increased. In addition, the operation of calculating the evaluation value of each objective image data and the operation of driving the imaging lens to a focus position on the basis of a plurality of evaluation values calculated are repeatedly performed. Thus, the image-capturing apparatus having the function of keeping on properly achieving focus on a subject while dealing with movement of the apparatus (camera), movement of the subject, and the like can be provided.

In a preferred aspect of the present invention, when the moving body detector detects that the subject is a moving body, the controller controls the image-capturing apparatus so as to enlarge the predetermined area in a direction substantially perpendicular to the ground line determined in each objective image.

Since the predetermined area to be subjected to calculation of an evaluation value which is set for each objective image is enlarged in the direction substantially perpendicular to the ground line, focus can be properly achieved on a subject more reliably. Particularly, a proper in-focus state on a subject can be realized while dealing with movement of the camera.

In another preferred aspect of the present invention, the image-capturing apparatus further comprises an image-capturing state detector for detecting an image-capturing state of the image-capturing apparatus. The controller controls the image-capturing apparatus so as to change the direction of enlarging the predetermined area in response to a detection result of the image-capturing state detector.

Since the direction of enlarging the predetermined area to be subjected to calculation of an evaluation value is changed on the basis of the image-capturing state such as a state of orientation of the image-capturing apparatus, according to a use state of the image-capturing apparatus by the user, focus can be properly achieved on a subject.

According to another aspect of the present invention, an image-capturing apparatus comprises: an image sensor for capturing an image through a lens and generating image data; a display for sequentially displaying a plurality of objective images based on a plurality of objective image data generated by the image sensor; a calculator for calculating an evaluation value of each objective image data as a function of evaluation image data corresponding to a predetermined area defined on each objective image; a driver for driving the lens to a focus position on the basis of a plurality of evaluation values calculated by the calculator; a moving body detector for detecting whether a subject is a moving body or not on the basis of image data generated for displaying an image of the subject on the display; and a controller, when the moving body detector detects that the subject is a moving body, for performing control of the image-capturing apparatus so as to change a distance of movement of the lens by the driver and to repeatedly enable the calculator and driver.

When the subject is a moving body, the movement distance of the imaging lens is changed by, for example, being increased. In addition, the operation of calculating the evaluation value of each objective image data and the operation of driving the imaging lens to a focus position on the basis of a plurality of evaluation values calculated are repeatedly performed. Thus, the image-capturing apparatus having the function of keeping on properly achieving focus on a subject while dealing with a subject that moves fast and the like can be provided.

According to still another aspect of the present invention, an image-capturing apparatus comprises: an image sensor for capturing an image through a lens and generating image data; a display for sequentially displaying a plurality of objective images based on a plurality of objective image data generated by the image sensor; a calculator for calculating an evaluation value of each objective image data as a function of evaluation image data corresponding to a predetermined area defined on each objective image; a driver for driving the lens to a focus position on the basis of a plurality of evaluation values calculated by the calculator; a moving body detector for detecting whether a subject is a moving body or not on the basis of image data generated for displaying an image of the subject on the display; and a controller, when the moving body detector detects that the subject is a moving body, for performing control of the image-capturing apparatus so as to change the number of the plurality of evaluation values and to repeatedly enable the calculator and driver.

When the subject is a moving body, the number of the plurality of evaluation values used at the time of determining a focus position of the imaging lens is changed by, for example, being inceased. In addition, the operation of calculating the evaluation value of each objective image data and the operation of driving the imaging lens to a focus position on the basis of a plurality of evaluation values calculated are repeatedly performed. Thus, the image-capturing apparatus having the function of keeping on properly achieving focus on a subject with higher precision while dealing with movement of the camera, movement of the subject, and the like can be provided.

Therefore, an object of the present invention is to provide an image-capturing apparatus having the function of keeping on properly achieving focus on a subject while dealing with movement of the camera, movement of the subject, and the like.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an image-capturing apparatus 1 according to an embodiment of the present invention;

FIG. 2 is a rear view of the image-capturing apparatus 1;

FIG. 3 is a block diagram showing the internal configuration of the image-capturing apparatus 1;

FIG. 4 is a diagram for describing detection of a panning state and a subject moving state;

FIG. 5 is a diagram illustrating an AF evaluation area;

FIG. 6 is a diagram illustrating the AF evaluation area;

FIG. 7 is a schematic diagram showing a curve expressing the relation between an evaluation value and the position of an imaging lens;

FIG. 8 is a schematic diagram showing a curve expressing the relation between an evaluation value and the position of the imaging lens;

FIG. 9 is a schematic diagram showing a curve expressing the relation between an evaluation value and the position of the imaging lens;

FIG. 10 is a flowchart showing an operation flow of a full-time AF operation; and

FIG. 11 is a schematic diagram showing a curve indicative of the relation between the evaluation value and the position of the imaging lens.

### DESCRIPTION OF THE PREFERRED EMBODIMENTS

Hereinafter, embodiments of the present invention will be described with reference to the drawings.

Main Components of Image-Capturing Apparatus 1

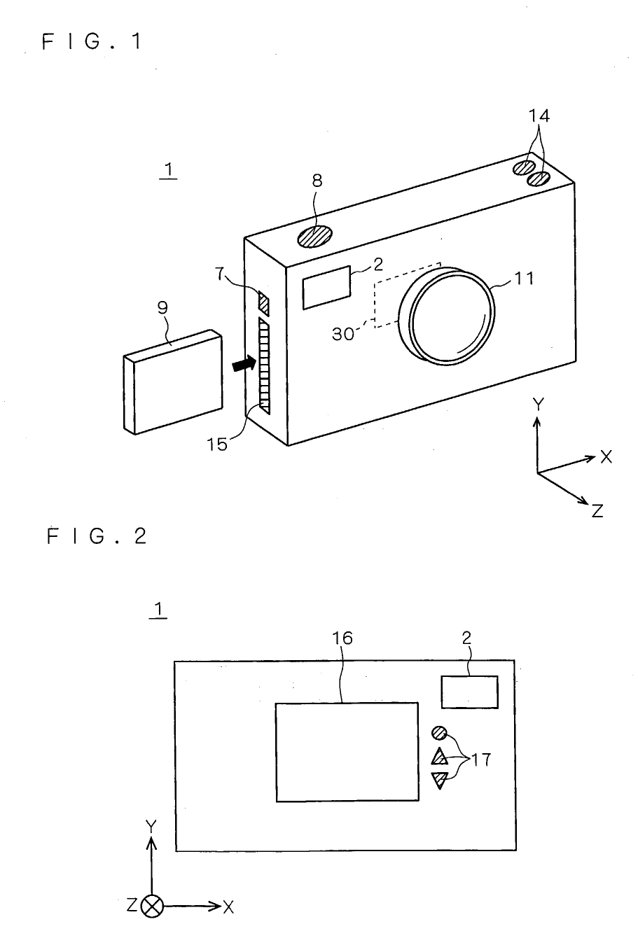

FIG. 1 is a perspective view showing an image-capturing apparatus (digital camera) 1 according to an embodiment of the present invention. FIG. 2 is a rear view of the image-capturing apparatus 1. In FIG. 1 and subsequent diagrams, three axes of X, Y, and Z which perpendicularly cross each other are shown in order to clarify the directional relations as necessary.

As shown in FIG. 1, an imaging lens 11 and a finder window 2 are provided on the front face side of the image-capturing apparatus 1. A CCD image-capturing device 30 is provided on the inside of the imaging lens 11. The CCD image-capturing device 30 photoelectrically converts a subject image entering via the imaging lens 11, thereby generating an image signal (signal formed by a sequence of pixel data of pixels).

The imaging lens 11 includes a lens unit which can be driven along the optical axis direction. By driving the lens unit in the optical axis direction, an in-focus state of the subject image formed on the CCD image-capturing device 30 can be realized.

On the top face side of the image-capturing apparatus 1, a shutter start button 8 and an image-capturing mode switching button 14 are disposed.

The image-capturing mode switching button 14 is a button for selecting and setting switching of the image-capturing mode at the time of an image-capturing operation by the image-capturing apparatus 1 and an image-capturing standby state by a manual operation. The image-capturing standby state denotes a state in which before an image-capturing operation (hereinafter, referred to as “image-capturing”) of obtaining an image and storing the image into a memory card 9 or the like, a live view image is displayed on a liquid crystal display 16. In the image-capturing standby state, by operating the image-capturing mode switching button 14, a mode of performing a normal auto-focus (AF) operation (hereinafter, referred to as “normal AF mode”) and a mode of performing a full-time auto-focus (AF) operation (hereinafter, referred to as “full-time AF mode”) can be set. The full-time AF operation denotes an AF operation of always achieving focus on a main subject in the finder window 2 (hereinafter, referred to as “main subject”) even if the shutter start button 8 is not depressed. The normal AF operation and the full-time AF operation will be described in detail later.

The shutter start button 8 is a button for giving an instruction of image-capturing to the image-capturing apparatus 1 when depressed by the user at the time of image-capturing a subject. That is, the shutter start button 8 functions as a button for instructing start of the image-capturing operation of the image-capturing apparatus 1. When touched or depressed, the shutter start button 8 can be set in two states of a touched state (hereinafter, referred to as “S1 state”) and a depressed state (hereinafter, referred to as “S2 state”). In the case where the normal AF mode is set in the image-capturing standby state, by setting the shutter start button 8 to the S1 state, a one-shot AF operation which will be described later is performed. By setting the shutter start button 8 to the S2 state, image-capturing which will be described later is performed.

In the case where the full-time AF mode is set, in the image-capturing standby state, before an operation of depressing the shutter start button 8, an AF operation of always achieving focus on the main subject is executed. When the S1 state is set, the driving of the imaging lens 11 is stopped and the full-time AF operation is stopped. The operation will be described more specifically later.

In a side face of the image-capturing apparatus 1, an insertion port 15 into which the removable memory card 9 can be inserted is formed. The memory card 9 to be inserted into the insertion port 15 can store image data obtained by the image-capturing operation accompanying the operation of depressing the shutter start button 8 by the user. Further, in the side face of the image-capturing apparatus 1, a card ejection button 7 is disposed. By depressing the card ejection button 7, the memory card 9 can be taken out from the insertion port 15.

As shown in FIG. 2, in the rear face of the image-capturing apparatus 1, the liquid crystal display 16, an operation button 17 and the finder window 2 are provided. On the liquid crystal display 16, a live view image, an image obtained by the image-capturing operation, and the like can be displayed. By operating the operation button 17, various setting states of the image-capturing apparatus 1 can be changed.

Functional Blocks of Image-Capturing Apparatus 1

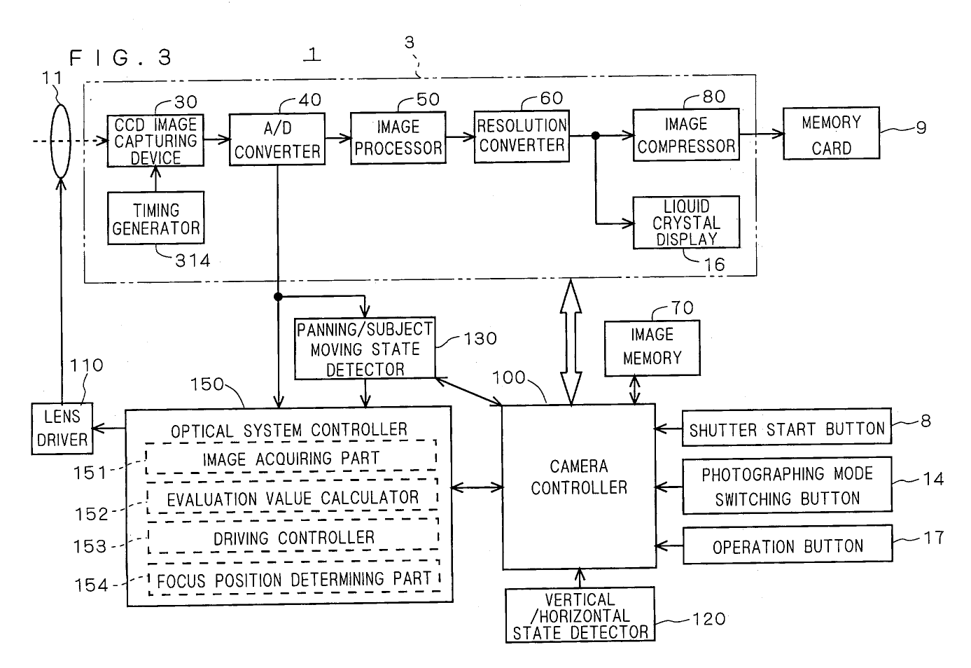

FIG. 3 is a block diagram showing the internal configuration of the image-capturing apparatus 1. As shown in FIG. 3, the image-capturing apparatus 1 is mainly constructed by an image-capturing function part 3, an optical system controller 150, a panning/subject moving state detector 130, a lens driver 110, and a camera controller 100. The image-capturing function part 3 is a part for processing an image signal (image data). The optical system controller 150 is a part for realizing an auto-focus (AF) operation. The panning/subject moving state detector 130 is a part for detecting whether the image-capturing apparatus 1 is panned to the right/left side (hereinafter, referred to as “panning state”) or not and whether the subject is moving (hereinafter, referred to as “subject moving state”) or not. The camera controller 100 is a part for controlling the components provided for the image-capturing apparatus 1 in a centralized manner.

The CCD image-capturing device 30 is a part functioning as an image-capturing part (image obtaining part) of obtaining an image of a subject and generating an electronic image signal. The CCD image-capturing device 30 has 2560×1920 pixels, photoelectrically converts a light image of a subject formed by the imaging lens 11 into image signals of color components of R (red), G (green), and B (blue) (signal formed by a signal sequence of pixel signals received by pixels) pixel by pixel, and outputs the image signals. In this case, an operation of exposing the CCD image-capturing device 30 and photoelectrically converting a light image of the subject is defined as “an input of an image”.

A timing generator 314 is a part of generating a drive control signal of the CCD image-capturing device 30 on the basis of a reference clock transmitted from the camera controller 100. The timing generator 314 generates, for example, clock signals such as timing signals of start and end of integration (start and end of exposure) and read control signals (horizontal sync signal, vertical sync signal, transfer signal, and the like) of photosensitive signals of pixels and outputs the signals to the CCD image-capturing device 30.

An image signal obtained from the CCD image-capturing device 30 is supplied to an A/D converter 40. In the image-capturing standby state, for example, on the basis of the drive control signal from the timing generator 314, an image signal is inputted from the CCD image-capturing device 30 to the A/D converter 40 every 1/30 second.

The A/D converter 40 is a part for converting an image signal (analog signal) outputted from the CCD image-capturing device 30 to a digital signal of 10 bits per pixel. At the time of image-capturing, an image signal outputted from the A/D converter 40 is transmitted only to an image processor 50. On the other hand, in the image-capturing standby state, an image signal outputted from the A/D converter 40 is transmitted to the image processor 50 and is transmitted also to the panning/subject moving state detector 130 and the optical system controller 150.

The image processor 50 is a part for performing image processes such as white balance adjustment, γ correction, and color correction on an image signal. An image signal outputted from the image processor 50 is led to a resolution converter 60.

The resolution converter 60 is a part for performing predetermined resolution conversion on an image signal (image) obtained from the CCD image-capturing device 30. For example, in the image-capturing standby state, the resolution converter 60 performs predetermined resolution conversion on image data inputted from the CCD image-capturing device 30. As a result, the resolution converter 60 generates image data of an image size adapted to the number of display pixels (320×240) of the liquid crystal display 16. Specifically, in the image-capturing standby state, on an image having 2560×240 pixels obtained by reducing pixels in the vertical direction to ⅛ in the CCD image-capturing device 30, the resolution converter 60 reduces the pixels in the horizontal direction in to ⅛, thereby generating a live view image having 320×240 pixels. At the time of the image-capturing, the resolution converter 60 outputs image data obtained from the image processor 50 as it is to an image compressor 80 without performing the resolution converting process.

An image memory 70 is a memory for temporarily storing image data obtained by the CCD image-capturing device 30 and subjected to the image processes. The image memory 70 has a storage capacity of at least a few frames. Specifically, the image memory 70 has a storage capacity capable of storing a few frames of pixel data of 2560×1920 pixels corresponding to the number of pixels of the CCD image-capturing device 30, and each pixel data is stored in a corresponding pixel position.

The image compressor 80 performs an image compressing process according to a predetermined compressing method on an image (2560×1920 pixels) obtained by image-capturing. An image signal (recording image) subjected to the image compressing process is outputted from the image compressor 80 and stored into the memory card 9.

The liquid crystal display 16 takes the form of a general liquid crystal display or the like and has 320×240 display pixels. In the image-capturing standby state, a live view image formed by 30 frames per second inputted from the resolution converter 60 is sequentially displayed on the liquid crystal display 16. At the time of image-capturing, immediately after the image-capturing, an after view image of a captured image is displayed on the liquid crystal display 16.

The panning/subject moving state detector 130 has the function of detecting whether the image-capturing apparatus 1 is in a panning state or not and the function of detecting whether a subject moving state in which the subject is a moving body is set or not. The functions of the panning/subject moving state detector 130 will be described in detail later.

The optical system controller 150 is constructed to obtain an image signal (image data) inputted from the A/D converter 40 and to control an AF operation of the contrast method. The optical system controller 150 is a part of receiving a plurality of image data (images) while driving the imaging lens 11 before image-capturing and mainly performing a focusing control of the imaging lens 11. The optical system controller 150 controls both the normal AF operation in the normal AF mode and the full-time AF operation in the full-time AF mode.

When the normal AF mode is set, by depression of the shutter start button 8, the AF operation by the optical system controller 150 is performed and the imaging lens 11 is driven to a focus position. After that, the image-capturing operation is performed and an image signal having 2560×1920 pixels obtained by the image-capturing is supplied to the image compressor 80. On the other hand, when the full-time AF mode is set in the image-capturing standby state, the optical system controller 150 controls the AF operation so that focus is always achieved on the main subject until the shutter start button 8 is depressed. The AF operations will be described in detail later.

The camera controller 100 is realized when a CPU executes a predetermined program. For example, when the user depresses any of various buttons including the shutter start button 8, image-capturing mode switching button 14 and operation button 17, according to the operation, the camera controller 100 controls the components of the image-capturing function part 3, panning/subject moving state detector 130, optical system controller 150, and lens driver 110. In the image-capturing standby state, when the full-time AF mode is set, based on detection of the panning state and the subject moving state by the panning/subject moving state detector 130, the camera controller 100 controls the optical system controller 150 so as to change the method of the AF operation.

In cooperation with the optical system controller 150 and the timing generator 314, when the lens position of the imaging lens 11 is driven step by step under control of the optical system controller 150 at the time of an AF operation, the camera controller 100 controls acquisition of image data by the CCD image-capturing device 30 in each of the lens positions.

In the case where the S1 state is set when the user touches the shutter start button 8 during the full-time AF operation to be described later, the camera controller 100 interrupts the full-time AF operation at that time point and controls the image-capturing apparatus 1 so as to fix the position of the imaging lens 11. Specifically, when the full-time AF mode is set in the image-capturing standby state, before an instruction of starting the image-capturing operation by the shutter start button 8, the camera controller 100 controls the image-capturing apparatus 1 so as to repeatedly execute a series of operations including acquisition of image data by an image acquiring part 151, calculation of an evaluation value by an evaluation value calculator 152, determination of a focus position of the imaging lens 11 by a focus position determining part 154, and driving to the focus position of the imaging lens 11 by a driving controller 153.

The lens driver 110 is a driving means for driving the imaging lens 11 along the optical axis backward/forward in accordance with an instruction from the optical system controller 150 and is a part of changing an in-focus state of a subject image formed on the CCD image-capturing device 30. That is, the lens driver 110 is a part of driving the imaging lens 11 to the focus position. The focus position is determined by the focus position determining part 154 to be described later which is provided for the optical system controller 150.

A vertical/horizontal state detector 120 is a part for detecting whether the image-capturing apparatus 1 is oriented in an substantially horizontal direction (hereinafter, referred to as “horizontal state”) or in an substantially vertical direction (hereinafter, referred to as “vertical state”). Specifically, the vertical/horizontal state detector 120 detects the state where the image-capturing apparatus 1 is ready to take a picture, that is, the image-capturing state of the image-capturing apparatus 1. In other words, the vertical/horizontal state detector 120 detects a direction substantially perpendicular to the ground line. The vertical/horizontal state detector 120 can be formed by, for example, a mercury switch or the like. When the XZ plane in FIG. 2 is assumed to be a horizontal plane to the ground line, the vertical/horizontal state detector 120 detects the state where the image-capturing apparatus 1 is oriented as shown in FIG. 2 as a horizontal state. On the other hand, the vertical/horizontal state detector 120 detects a state where the image-capturing apparatus 1 shown in FIG. 2 is turned by about 90° in the XY plane as a vertical state.

Panning/Subject Moving State Detector

The panning/subject moving state detector 130 has the function of detecting whether the image-capturing apparatus 1 is in the panning state or not and the function of detecting whether a subject is in a subject moving state in which a subject is a moving body. The functions of the panning/subject moving state detector 130 will be described concretely below.

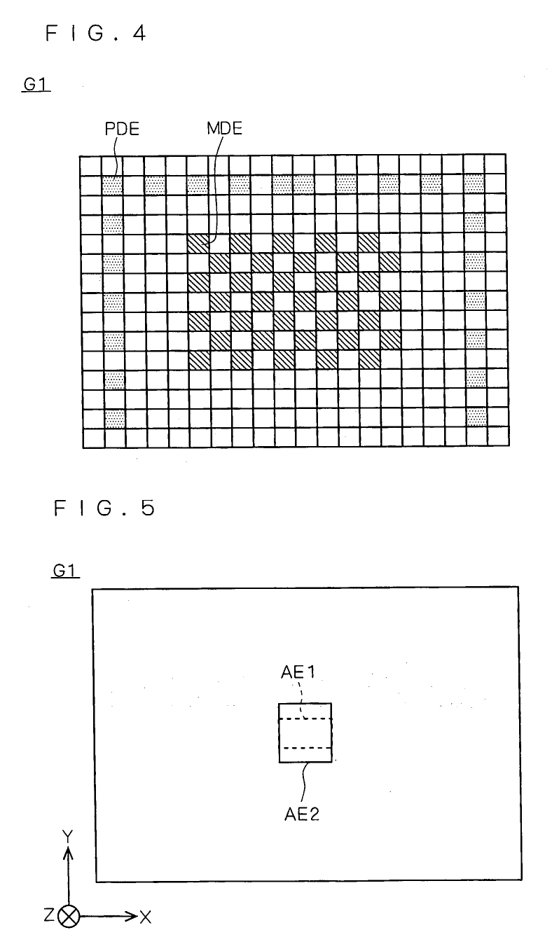

FIG. 4 is a diagram for describing detection of the panning state and the subject moving state. In the panning/subject moving state detector 130, an image G1 obtained by reducing pixels in the vertical direction to ⅛ in the CCD image-capturing device 30 and based on image data having 2560×240 pixels inputted from the A/D converter 40 is divided into, for example, blocks each having 128×16 pixels (hereinafter, referred to as “evaluation blocks”) and image data is evaluated on the block unit basis. In FIG. 4, in order to clarify the correspondence to the positions of pixels in the CCD image-capturing device 30, the image G1 is enlarged by eight times in the vertical direction in which the pixels have been reduced to ⅛ in the CCD image-capturing device 30. FIG. 4 shows that the image G1 is divided into the evaluation blocks each having 128×16 pixels. That is, FIG. 4 shows a state where the image G1 is divided into 20 blocks in the lateral direction, 15 blocks in the vertical direction, and total 300 evaluation blocks.

The panning/subject moving state detector 130 calculates, for example, as shown in FIG. 4, an integration value of pixel values of pixels included in halftone 22 evaluation blocks PDE (hereinafter, referred to as “panning evaluation blocks”) near the periphery of the image G1 and hatched 35 evaluation blocks (hereinafter, referred to as “subject movement evaluation blocks”) MDE in a center portion of the image G1.

The panning/subject moving state detector 130 calculates a change amount in integration values of the pixel values in the 22 panning evaluation blocks PDE between two continuous image data pieces which are inputted from the A/D converter 40 every 1/30 second in order to detect a panning state. In order to detect the subject moving state, the panning/subject moving state detector 130 calculates a change amount in integration values of pixel values in the 35 subject movement evaluation blocks MDE between two continuous image data pieces inputted from the A/D converter 40 every 1/30 second. The panning/subject moving state detector 130 calculates a time change amount of an integration value of pixel values of all of the panning evaluation blocks PDE (hereinafter, referred to as “panning evaluation value”) and a time change amount of an integration value of pixel values of all of the subject movement evaluation blocks MDE (hereinafter, referred to as “subject moving state evaluation value”).

For example, when the panning evaluation value is equal to or larger than a predetermined threshold and the subject moving state evaluation value is equal to or larger than a predetermined threshold, the panning/subject moving state detector 130 detects a panning state. When the panning evaluation value is smaller than the predetermined threshold and the subject moving state evaluation value is equal to or larger than a predetermined threshold, the panning/subject moving state detector 130 detects a subject moving state.

As described above, an image signal inputted form the A/D converter 40 to the panning/subject moving state detector 130 in the image-capturing standby state is simultaneously also transmitted to the image processor 50 in order to generate a live view image. Specifically, the panning/subject moving state detector 130 detects a subject moving state in which the subject is a moving body on the basis of an image to be displayed on the liquid crystal display 16. Further, the panning/subject moving state detector 130 detects a panning state included in a state where the optical axis direction (image-capturing direction) of the imaging lens 11 changes by a predetermined amount or more (hereinafter, referred to as “image-capturing direction change state”).

Optical System Controller

As shown in FIG. 3, the optical system controller 150 has the image acquiring part 151, evaluation value calculator 152, drive controller 153, and focus position determining part 154. The optical system controller 150 obtains an image signal corresponding to an auto-focus evaluation area (AF evaluation area) to be described later from image signals constructed by 2560×240 pixels inputted from the A/D converter 40 and performs an AF operation according to the contrast method. That is, the optical system controller 150 controls the image-capturing apparatus 1 so as to lead a subject image formed on the CCD image-capturing device 30 to a focus position by the imaging lens 11.

As described above, the image signals inputted from the A/D converter 40 to the optical system controller 150 are simultaneously transmitted from the A/D converter 40 to the image processor 50 in order to generate a live view image. In the above-described AF operation, a plurality of images inputted by the CCD image-capturing device 30 while driving the imaging lens 11 are sequentially displayed on the liquid crystal display 16.

The optical system controller 150 have functions which are different from each other in the normal AF mode and the full-time AF mode. In the full-time AF mode of the present invention, an initial operation in the AF operation is similar to the normal AF operation. Therefore, the function of the optical system controller 150 in the normal AF mode will be briefly described first and, after that, the function of the optical system controller 150 in the full-time AF mode of the present invention will be described.

Function of Optical System Controller in Normal AF Mode

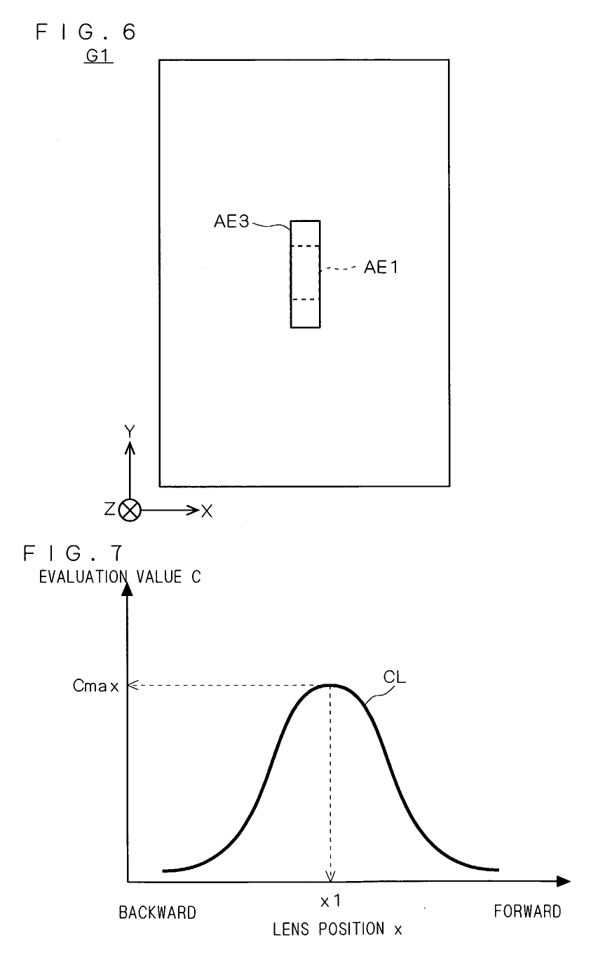

FIGS. 5 and 6 are diagrams each illustrating an AF evaluation area. FIG. 5 shows a case where the image-capturing apparatus 1 is in the horizontal state and FIG. 6 shows a state where the image-capturing apparatus 1 is in the vertical state. FIG. 5 shows that, in order to clarify the correspondence to the positions of pixels in the CCD image-capturing device 30, the image G1 is enlarged by eight times in the vertical direction (Y direction) in which the pixels are reduced to ⅛ in the CCD image-capturing device 30. FIG. 6 shows that the image G1 is enlarged by eight times in the horizontal direction (X direction) in which the pixels are reduced to ⅛ in the CCD image-capturing device 30.

In the normal AF mode, the image acquiring part 151 acquires image data corresponding to an AF evaluation area AE1 having 320×24 pixels in a center portion in the image G1 based on image signals having 2560×240 pixels inputted from the A/D converter 40. In a manner similar to the operation performed in a general AF operation of the contrast method, while driving the imaging lens 11, the image acquiring part 151 inputs a plurality of image data in the AF evaluation area AE1.

The evaluation value calculator 152 calculates an evaluation value regarding an in-focus state of the imaging lens 11 on the basis of image data acquired by the image acquiring part 151. The evaluation value is calculated as a sum of contrast values in the AF evaluation area AE1 in a manner similar to calculation in a general AF operation of the contrast method. That is, the evaluation value calculator 152 calculates an evaluation value regarding an in-focus state of the imaging lens 11 with respect to the AF evaluation area AE1 which is set for each of the plurality of images which are inputted while driving the imaging lens 11.

The driving controller 153 controls the driving of the imaging lens 11 in the optical axial direction under control of the timing generator 314 and camera controller 100. By the driving controller 153, to obtain image data for an AF operation or to lead the imaging lens 11 to a focus position determined by the focus position determining part 154, the driving of the imaging lens 11 in the optical axis direction is controlled. When the driving of the imaging lens 11 to the in-focus state is completed, the driving controller 153 transmits a signal indicative of the completion to the camera controller 100 and timing generator 314. By the operation, after completion of the driving of the imaging lens 11 to the focus position, various operations can be performed.

The focus position determining part 154 determines the focus position of the imaging lens 11 on the basis of the evaluation value calculated by the evaluation value calculator 152 in a manner similar to a general AF operation of the contrast method.

FIG. 7 is a schematic diagram showing a curve CL showing the relation between an evaluation value C and a position “x” in the optical axis direction of the imaging lens 11. As shown in FIG. 7, when the imaging lens 11 exists in the focus position (x=x1), the evaluation value C is the largest. The AF operation of the contrast method is performed by comparing the evaluation values C of at least two images obtained in different positions “x” in the optical axis direction of the imaging lens 11. Concretely, the evaluation values C of two images are compared with each other and the imaging lens 11 is driven in the direction in which the evaluation value C increases. By repeating such an operation to drive the imaging lens 11, the imaging lens 11 can be driven to a focus position x1.

Function of Optical System Controller in Full-Time AF Mode

When the full-time AF mode is set in the image-capturing standby state, first, an AF operation similar to an AF operation (hereinafter, referred to as “one-shot AF operation”) in the normal AF mode is performed to drive, for example, the imaging lens 11 to the focus position x1. After that, on the basis of a detection result of the panning state and the subject moving state by the panning/subject moving state detector 130, the full-time AF operation is performed.

Concretely, when both the panning state and the subject moving state are not detected by the panning/subject moving state detector 130, the camera controller 100 determines that the position of the main subject and the composition hardly change and the focus position of the imaging lens 11 is unchanged. In this case, the image acquiring part 151 does not acquire new image data under control of the camera controller 100. As a result, the evaluation value calculator 152 does not newly calculate an evaluation value and it is controlled so that the imaging lens 11 is not driven in the optical axis direction by the driving controller 153.

When the panning state or the subject moving state (panning/subject moving state) is detected by the panning/subject moving state detector 130, the full-time AF operation is performed as follows. Concretely, different full-time AF operations are performed by the panning/subject moving state detector 130 in the following three cases:

(1) a case where both the panning state and the subject moving state are not detected after detection of the panning state,

(2) a case where only the subject moving state is detected or only the subject moving state is detected after detection of the panning state, and

(3) a case where the panning state is continuously detected. The functions and the like of the optical system controller 150 in the full-time AF operations in the following three cases (1) to (3) will be described.

(1) Case Where Both the Panning State and the Subject Moving State are not Detected After Detection of the Panning State

When the panning state is detected by the panning/subject moving state detector 130, an operation of detecting the panning/subject moving state is repeatedly performed until the panning state becomes undetected. When the panning state becomes undetected, in the case where the subject moving state is not detected by the panning/subject moving state detector 130 (both the panning state and the subject moving state are not detected), under control of the driving controller 153, while driving the imaging lens 11 forward and backward with respect to the focus position of last time as a center within a predetermined range in the optical axis direction, the image acquiring part 151 acquires image data from the AF evaluation area AE1 shown in FIGS. 5 and 6. At this time, the image acquiring part 151 acquires image data in a plurality of positions of the imaging lens 11 within a predetermined range around the focus position of last time as a center until the next focus position is determined. The focus position of last time denotes the focus position determined by the focus position determining part 154 most recently. For example, immediately after the one-shot AF operation in the early stage of the full-time AF operation, the focus position of last time is the focus position x1 determined in the one-shot AF operation.

The evaluation value calculator 152 calculates the evaluation value of the in-focus state of the imaging lens 11 with respect to plurality of image data obtained by the image acquiring part 151. Further, the focus position determining part 154 determines the focus position of the imaging lens 11 on the basis of the evaluation value calculated by the evaluation value calculator 152. After that, the driving controller 153 controls the driving of the imaging lens 11 in the optical axis direction so as to lead the imaging lens 11 to the focus position determined by the focus position determining part 154.

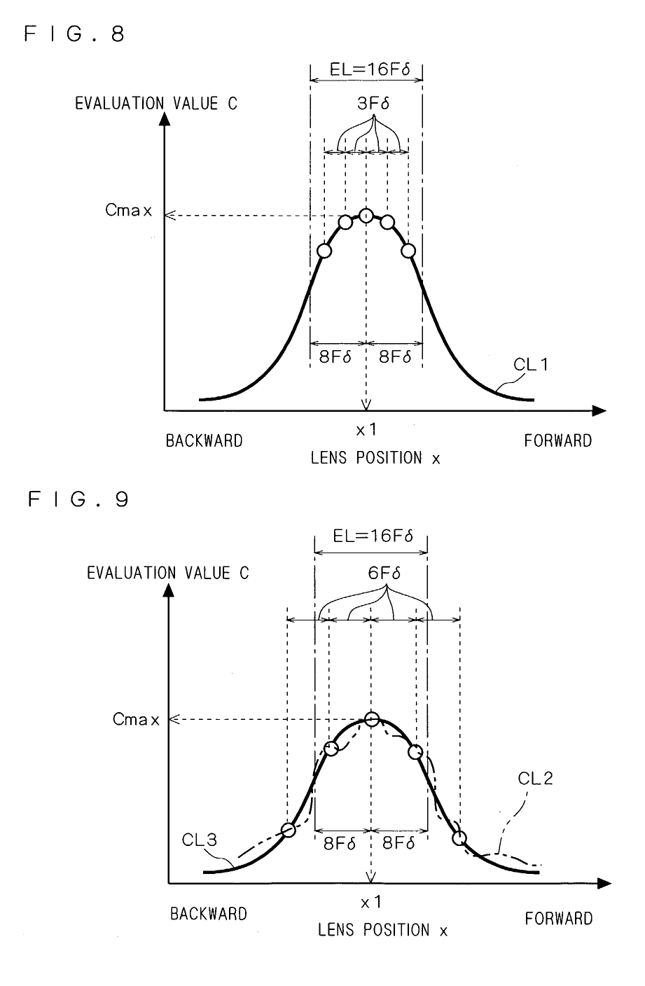

FIG. 8 is a schematic diagram showing a curve CL1 indicative of the relation between the evaluation value C at this time and the position of the imaging lens 11. The curve CL1 is, as an example, a curve showing the relation between the evaluation value C obtained at the time of driving the imaging lens 11 forward and backward in the optical axis direction around the focus position x1 obtained by the one-shot AF operation at the early stage of the full-time AF operation as a center and the position of the imaging lens 11. Blank circles shown in FIG. 8 indicate the positions (hereinafter, also referred to as “sampling positions”) of the imaging lens 11 in which the image acquiring part 151 acquires image data during a period from the time point when the focus position of last time is determined by the focus position determining part 154 to the time point when the next focus position is determined. The blank circles also show the evaluation values calculated by the evaluation value calculator 152 with respect to the image data obtained by the image acquiring part 151. The curve CL1 is a curve obtained by performing curve approximation on the basis of the evaluation values C in the sampling positions indicated by the blank circles.

In the full-time AF operation, generally, the AF operation is repeatedly performed promptly so as to always achieve focus on the subject. Consequently, as shown in FIG. 8, while driving the imaging lens 11 forward and backward in the optical axis direction around the focus position x1 of last time as a center, the interval between sampling positions (hereinafter, also referred to as “sampling pitch”) is set to 3Fδ. F denotes the f number (aperture value) of the imaging lens 11 and 6 indicates a permissible circle of confusion of the CCD image-capturing device 30. As a result, as shown in FIG. 8, the image acquiring part 151 acquires image data in total five positions of the focus position x1, two positions before the focus position x1, and two positions after the focus position x1. The evaluation value calculator 152 calculates the evaluation values C with respect to image data obtained in the five positions. By performing curve approximation on the basis of the evaluation values C in the five positions, the curve CL1 is calculated. Further, the focus position determining part 154 determines the lens position in which the curve CL1 is the maximum as the next focus position. FIG. 8 illustrates, to simplify the drawing, the state where the next focus position is similar to the focus position x1 of last time.

On the basis of an image signal obtained by the CCD image-capturing device 30 in the position of the imaging lens 11 of a blank circle shown in FIG. 8, a live view image is displayed on the liquid crystal display 16. As described above, the live view image displayed on the liquid crystal display 16 is an image consisting of 320×240 pixels obtained by reducing an image consisting of 2560×1920 pixels acquired by the CCD image-capturing device 30 to ⅛ in each of the vertical and horizontal directions. Therefore, a permissible range in which the live view image is not blurred even if the imaging lens 11 is deviated from the focus position, that is, depth of field converted for a live view image (hereinafter, referred to as “depth of field live view conversion value”) EL is about 8 Fδ. That is, when the imaging lens 11 is positioned within a deviation range of about 8 Fδ before or after the focus position in the optical axis direction, the live view image is not blurred.

For example, as shown in FIG. 8, the image acquiring part 151 acquires image data in total five positions of the focus position x1, two positions before the focus position x1 and two positions after the focus position x1 so that the sampling pitch becomes 3Fδ in the optical axial direction around the focus position x1 as a center. The drive width of the imaging lens 11 at this time is 6Fδ on each of the forward and backward sides of the focus position x1 as a center. Consequently, the imaging lens 11 is within the range of the depth of field live view conversion value EL=8 Fδ. As a result, the live view image is not blurred. Thus, the picture quality of the live view image is high and the AF operation which is easy to operate for the user can be realized.

The AF operation of obtaining image data by the image acquiring part 151 in total five positions of the focus position of last time, two positions before the focus position, and two positions after the focus position so that the sampling pitch in the optical direction around the focus position of last time becomes 3F6 and determining the next focus position will be also called an “AF operation performed at a small sampling pitch” below.

(2) Case Where Only Subject Moving State is Detected and Case Where Only Subject Moving State is Detected After Detection of Panning State

When the panning state is detected by the panning/subject moving state detector 130, the operation of detecting the panning/subject moving state is repeated until the panning state becomes undetected. In the case where only the subject moving state is detected by the panning/subject moving state detector 130 when the panning state becomes undetected, and in the case where only the subject moving state is detected from the beginning, in a manner similar to the case where neither the panning state nor the subject moving state is not detected after detection of the panning state, during the period from the time point when the focus position of last time is determined to the time point when the next focus position is determined, the image acquiring part 151 acquires image data when the imaging lens 11 is positioned in total five positions of the focus position of last time and two positions each before and after the focus position of last time. Under control of the camera controller 100, a series of operations including acquisition of a plurality of image data by the image acquiring part 151, calculation of a plurality of evaluation values by the evaluation value calculator 152, determination of a focus position of the imaging lens 11 by the focus position determining part 154, and driving to the focus position of the imaging lens 11 by the driving controller 153 is repeatedly performed.

However, when only the subject moving state is detected by the panning/subject moving state detector 130, under control of the camera controller 100, the size of the AF evaluation area is changed on the basis of the detection result of the vertical/horizontal state detector 120. For example, when it is detected by the vertical/horizontal state detector 120 that the image-capturing apparatus 1 is in the horizontal state, as shown in FIG. 5, the AF evaluation area AE1 is changed to an AF evaluation area AE2. The AF evaluation area AE2 is an area (area having 320×48 pixels) obtained by enlarging the AF evaluation area AE1 in the direction substantially perpendicular to the ground line. On the other hand, when it is detected by the vertical/horizontal state detector 120 that the image-capturing apparatus 1 is in a vertical state, as shown in FIG. 6, the AF evaluation area AE1 is changed to an AF evaluation area AE3. The AF evaluation area AE3 is an area (area having 640×24 pixels) obtained by enlarging the AF evaluation area AE1 in the direction substantially perpendicular to the ground line.

Specifically, in the case where only the subject moving state is detected by the panning/subject moving state detector 130, based on the detection of the subject moving state, the camera controller 100 controls the image-capturing apparatus 1 so as to enlarge the AF evaluation area in the direction substantially perpendicular to the ground line. At this time, the camera controller 100 controls the image-capturing apparatus 1 so as to enlarge the AF evaluation area in the direction substantially perpendicular to the ground line on the basis of detection of the vertical and horizontal states by the vertical/horizontal state detector 120, that is, detection in the direction substantially perpendicular to the ground line. In other words, the camera controller 100 controls the image-capturing apparatus 1 so as to change the enlargement direction of the AF evaluation area on the basis of a detection result of the image-capturing state of the image-capturing apparatus 1 by the vertical/horizontal state detector 120.

In the subject moving state, it is feared that the area of a main subject included in the AF evaluation area largely changes with time. Consequently, by enlarging the AF evaluation area as described above, a large change with time in the area of the main subject included in the AF evaluation area is suppressed. As a result, the possibility that the portion of the main subject existing in the AF evaluation area at the time of obtaining the focus position of last time also exists in the AF evaluation area also at the time of computing the focus position of next time can be increased. That is, by capturing the main subject continuously in the AF evaluation area, the in-focus state on the main subject can be more properly realized.

A general main moving subject is a human being or the like. Since a human being is long in the vertical direction, if the AF evaluation area is enlarged in the direction horizontal to the ground line, the possibility that the AF evaluation area largely extends in the horizontal direction to the ground line more than the human as a main subject is high. Specifically, when the AF evaluation area is enlarged in the direction horizontal to the ground line, a distant view as a background is included much more in the AF evaluation area, and the possibility of occurrence of a phenomenon that focus is not achieved on the main subject as a close view (so-called far-and-near competition) is high. Consequently, in the case where only the subject moving state is detected by the panning/subject moving state detector 130, the AF evaluation area set for each image obtained by the image acquiring part 151 is enlarged in the direction perpendicular to the ground line. As a result, focus can be properly achieved on a subject more reliably. In particular, focus can be properly achieved on the subject while dealing with movement of the apparatus (camera) which often occurs before operation of the shutter start button 8.

In this case, the direction substantially perpendicular to the ground line is detected by the vertical/horizontal state detector 120, the direction of enlarging the AF evaluation area is changed on the basis of the image-capturing state of the image-capturing apparatus 1, and the AF evaluation area is enlarged in the direction substantially perpendicular to the ground line. As a result, according to a use state of the image-capturing apparatus 1 by the user, focus can be achieved properly on a subject.

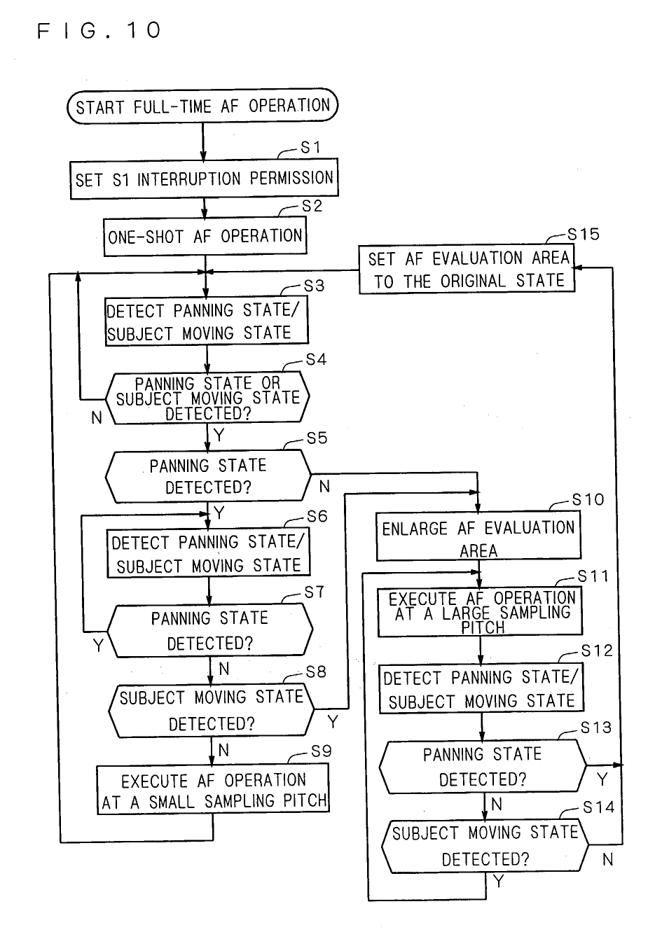

FIG. 9 is a schematic diagram showing curves CL2 and CL3 each showing the relation between the evaluation value C in the case where only the subject moving state is detected by the panning/subject moving state detector 130 and the position of the imaging lens 11. The curve CL3 shows, as an example, the relation between the evaluation value C obtained when the imaging lens 11 is driven forward and backward in along the optical axis direction around the focus position x1 as a center computed in the one-shot AF operation at the early stage of the full-time AF operation and the position of the imaging lens 11. Each of blank circles shown in FIG. 9 indicates the position (sampling position) of the imaging lens 11 in which the image acquiring part 151 acquires image data in the period from the time point when the focus position of last time is determined by the focus position determining part 154 to the time point when the next focus position is determined and the evaluation value calculated by the evaluation value calculator 152 on image data obtained by the image acquiring part 151 in a manner similar to FIG. 8. The curve CL3 indicates a curve obtained by curve approximation based on the evaluation values C in the sampling positions expressed by the blank circles.

In the subject moving state, the main subject tends to exist out of the AF evaluation area. In such a case, also by the influence of movement of the main subject itself, for example, the curve of the evaluation values C fluctuates as shown by the curve CL2 and an evaluation value Cmax at the peak of the curve CL2 tends to become small. The curve CL2 shows an example of the fluctuating curve of the evaluation values C.

In the full-time AF operation, as described above, generally, the AF operation is repeatedly performed so as to always achieve focus on the subject. Consequently, as shown in FIG. 9, while driving the imaging lens 11 forward and backward in the optical axis direction around the focus position x1 of last time as a center, the interval of the sampling positions (sampling pitch) is set to 6Fδ. Specifically, when only the subject moving state is detected by the panning/subject moving state detector 130, under control of the camera controller 100, the sampling pitch is changed to increase to 6Fδ. In other words, under control of the camera controller 100, based on detection of the subject moving state by the panning/subject moving state detector 130, the interval between the positions of the imaging lens 11 for inputting a plurality of images is changed so as to increase.

As a result, as shown in FIG. 9, the image acquiring part 151 acquires image data in total five positions of the focus position x1, two positions before the focus position x1, and two positions after the focus position x1. The evaluation value calculator 152 calculates the evaluation values C on the image data obtained in the five positions and approximates the evaluation values C in the five positions to a curve, thereby calculating the curve CL3. The focus position determining part 154 determines the lens position at the maximum point of the curve CL3 with respect to the evaluation value C as the next focus position. FIG. 9 shows, for simplifying the diagram, a state where the next focus position is similar to the focus position x1 of last time.

The sampling pitch is increased to 6Fδ for the reason that the next focus position is determined more reliably. Concretely, in the subject moving state, as shown by the curve CL2 in FIG. 9, the curve of the evaluation values C tends to fluctuate. Therefore, when the sampling pitch remains as short as 3Fδ as shown in FIG. 8, the curve is largely influenced by a fluctuation in the evaluation value C and the lens position X at the maximum value of the curve obtained by curve approximation based on the evaluation values C in the five positions tends to be deviated from the actual focus position. That is, the imaging lens 11 tends to be deviated from the proper focus position on the main subject. In this case, due to the influence of the fluctuation in the evaluation value C, the change amount in the evaluation values C in the five positions tends to decrease. It becomes difficult to calculate the maximum value of the curve obtained by curve approximation and the tendency of a deviation from the proper focus position increases.

For example, as shown in FIG. 9, the image acquiring part 151 acquires image data in total five positions of the focus position of last time, two positions before the focus position, and two positions after the focus position so that the sampling pitch in the optical axis direction around the focus position of last time as a center becomes 6Fδ. By increasing the sampling pitch from 3Fδ to 6Fδ, the influence of fluctuations of the evaluation values C can be made small relatively and the change amount in the five evaluation values C with respect to image data obtained in five sampling positions can be increased. As a result, the lens position X at the maximum value in the curve CL3 obtained by curve approximation based on the evaluation values C in the five sampling positions becomes a position close to the proper focus position. That is, the state can be made close to the state in which focus is properly achieved on a main subject.

The driving width of the imaging lens 11 at this time is, as shown in FIG. 9, 12Fδ in each of the forward and backward in the optical axis direction from the focus position x1 of last time. Therefore, in this case, the driving width of the imaging lens 11 lies slightly out of the range of the depth of field live view conversion value EL=8Fδ. As a result, a live view image displayed on the liquid crystal display 16 is blurred a little. However, by increasing the sampling pitch as described above, the focus position can be determined promptly and more reliably, so that focus on the subject can be realized with reliability.

The AF operation of obtaining image data by the image acquiring part 151 in total five positions of the focus position of last time, two positions before the focus position, and two positions after the focus position so that the sampling pitch becomes 6Fδ in the optical axis direction around the focus position of last time as a center and determining the next focus position will be also called an “AF operation performed at a large sampling pitch”.

(3) Case Where the Panning State is Continuously Detected

In the case where the panning state is detected by the panning/subject moving state detector 130, until the panning state becomes undetected, the operation of detecting the panning/subject moving state is performed. In the case where the panning state is continuously detected by the panning/subject moving state detector 130, the image acquiring part 151 does not acquire image data from the AF evaluation value AE1. That is, when the panning state is detected, the series of operations including acquisition of a plurality of image data by the image acquiring part 151, calculation of a plurality of evaluation values by the evaluation value calculator 152, determination of a focus position of the imaging lens 11 by the focus position determining part 154, and driving to the focus position of the imaging lens 11 by the driving controller 153 is inhibited by the camera controller 100.

The case where the panning state is detected denotes a case where the optical axis direction of the imaging lens 11 of the image-capturing apparatus. 1 largely changes. Therefore, in such a case, the position of the subject relative to the image-capturing apparatus 1 largely changes and it is very difficult to determine a focus position by the AF operation. For example, even if the imaging lens 11 is driven to the forward and backward in the optical axis direction around the focus position of last time as a center, focus is not achieved on a main subject, and power is wasted for the AF operation by which focus cannot be achieved. Further, when the imaging lens 11 is driven in vain forward and backward in the optical axis direction in a state where focus is not achieved on a main subject, a live view image is displayed on the liquid crystal display 16 while the degree of blur of the live view image changes with time. In such a case, the user watching the live view image feels unpleasant.

Depending on settings of the image-capturing apparatus, in the case where a sharp peak of the evaluation values C cannot be found even when the imaging lens 11 is driven forward and backward in a predetermined range in the optical axis direction around the focus position of last time as a center, an operation of searching for a sharp peak of the evaluation values C by obtaining image data while driving the imaging lens 11 from end to end of the drivable range (low contrast scan) is performed and the power is wasted.

In the image-capturing apparatus 1, therefore, in the case where the punning state as one of states in which the optical axis direction of the imaging lens 11 changes by a predetermined amount or more is detected on the basis of an image to be displayed on the liquid crystal display 16, from the viewpoints of both power saving and ease of operation for the user, the series of operations including acquisition of a plurality of image data by the image acquiring part 151, calculation of a plurality of evaluation values by the evaluation value calculator 152, determination of a focus position of the imaging lens 111 by the focus position determining part 154, and driving to the focus position of the imaging lens 11 by the driving controller 153 is inhibited. Therefore, a live view image of which degree of blur changes with time is not displayed on the liquid crystal display 16 so that the user does not feel unpleasant. As a result, power of the image-capturing apparatus 1 can be saved and ease of operation for the user can be improved.

Even in the case of inhibiting the series of operations including acquisition of a plurality of image data by the image acquiring part 151, calculation of a plurality of evaluation values by the evaluation value calculator 152, determination of a focus position of the imaging lens 11 by the focus position determining part 154, and driving to the focus position of the imaging lens 11 by the driving controller 153, the panning/subject moving state detector 130 performs the operation of receiving image data from the A/D converter 40, calculating the panning evaluation value and the subject moving state evaluation value, and detecting the subject moving state and the panning state.

The operation of the image-capturing apparatus 1 in the full-time AF mode will be described specifically below.

Full-Time AF Operation of Image-Capturing Apparatus

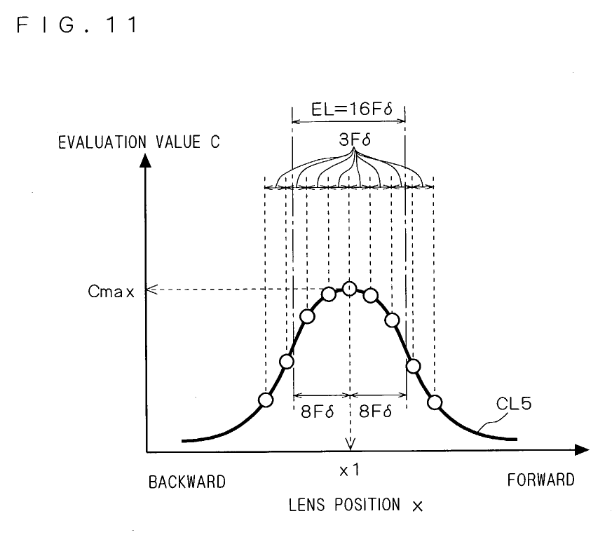

FIG. 10 is a flowchart showing an example of the operation flow of the full-time AF operation. The operation flow of the full-time AF operation is realized by cooperation of the camera controller 100, panning/subject moving state detector 130, and optical system controller 150 under control of the camera controller 100.

First, in the image-capturing standby state, when the user operates the image-capturing mode switching button 14 to set the “full-time AF mode”, the full-time AF operation starts and the program advances to step S1 shown in FIG. 10.

In step S1, a setting of permitting interruption of the S1 state as a state where the shutter start button 8 is touched is made, and the program advances to step S2. Concretely, the setting is made in such a manner that, in the operation flow shown in FIG. 10, when the user touches the shutter start button 8 and the S1 state is set, at the time point, the operation flow shown in FIG. 10 is interrupted and the position of the imaging lens 11 is fixed.

As described above, based on the instruction of starting the image-capturing operation by depression of the shutter start button 8 of the user, the camera controller 100 inhibits the driving of the imaging lens 1. In other words, before the instruction of starting the image-capturing operation by the user, the series of operations including acquisition of a plurality of image data by the image acquiring part 151, calculation of a plurality of evaluation values by the evaluation value calculator 152, determination of a focus position of the imaging lens 11 by the focus position determining part 154, and driving to the focus position of the imaging lens 11 by the driving controller 153 is repeatedly executed. In response to the instruction of starting the image-capturing operation, the camera controller 100 controls the image-capturing apparatus 1 so as to stop the series of operations. As a result, at the time point when the instruction of starting the image-capturing operation is given by the user, the position of the imaging lens 11 is fixed, so that the image-capturing according to the intention of the user can be realized.

In step S2, a one-shot AF operation similar to the normal AF operation is performed and the program advances to step S3. In this case, an operation on the shutter start button 8 is not performed but an operation similar to the normal AF operation is executed. The imaging lens 11 is driven to a focus position in which focus is achieved on the main subject.

In step S3, the panning state and the subject moving state are detected, and the program advances to step S4. In this case, whether or not the panning state or the subject moving state is set is detected by the panning/subject moving state detector 130.

In step S4, whether the panning state or the subject moving state has been detected in step S3 or not is determined. If at least one of the panning state and the subject moving state is detected in step S3, the program advances to step S5. If both of the panning state and the subject moving state are not detected in step S3, the program returns to step S3. That is, until at least one of the panning state and the subject moving state is detected, the processes in steps S3 and S4 are repeatedly performed.

In step S5, whether the panning state is detected in step S3 or not is determined. If YES, the program advances to step S6. If NO, the program advances to step S10. The case where the panning state is not detected in step S3 corresponds to the case where the subject moving state is detected.

In step S6, in a manner similar to step S3, the panning state and the subject moving state are detected again, and the program advances to step S7.

In step S7, whether the panning state has been detected in step S6 or not is determined. If YES, the program returns to step S6. If NO, the program advances to step S8. That is, until the panning state is finished, the processes in steps S6 and S7 are repeatedly performed.

In step S8, whether the subject moving state has been detected in step S6 or not is determined. If YES, the program advances to step S1. If NO, the program advances to step S9.

In step S9, the AF operation performed at a small sampling pitch is performed, and the program returns to step S3. Since the AF operation performed at a small sampling pitch has been already described, the description will not be repeated here.

In step S10, the AF evaluation area is enlarged, and the program advances to step S11. As shown in FIGS. 5 and 6, the AF evaluation area AE1 is enlarged so as to be doubled in the direction perpendicular to the ground line, thereby obtaining the AF evaluation areas AE2 and AE3.

In step S11, the AF operation performed at a large sampling pitch is performed, and the program advances to step S12. Since the AF operation performed at a large sampling pitch has been already described, the description will not be repeated here.

In step S12, in a manner similar to steps S3 and S6, the panning state and the subject moving state are detected, and the program advances to step S13.

In step S13, whether the panning state has been detected in step S12 or not is determined. If YES, the program advances to step S115. If NO, the program advances to step S14.

In step S14, whether the subject moving state has been detected in step S12 or not is determined. If YES, the program returns to step S11. If NO, the program advances to step S15.

In step S15, the AF evaluation area enlarged in step S10 is reset to the original size and the program returns to step S3. As shown in FIGS. 5 and 6, the AF evaluation areas AE2 and AE3 are reduced to the original size of the AF evaluation area AE1.

After that, until the setting of the full-time AF mode is canceled or the shutter start button 8 is operated to set the S1 state, the processes from step S3 to step S15 are repeatedly performed.

As described above, in the image-capturing apparatus 1 according to the embodiment of the present invention, in the case where the subject moving state is detected by the panning/subject moving state detector 130 when the full-time AF mode is set and the full-time AF operation is performed, the AF evaluation area is enlarged. The series of operations including calculation of the evaluation value C regarding the in-focus state of the imaging lens 11 on a plurality of image data obtained, determination of a focus position of the imaging lens 11 based on the evaluation values C, and driving to the determined focus position of the imaging lens 11 is repeatedly performed. As a result, the easy-to-operate image-capturing apparatus having the full-time AF function of continuously properly achieving focus on a subject while dealing with movement of the camera, movement of the subject, and the like can be provided.

In the case where the subject moving state is detected by the panning/subject moving state detector 130 in a state where the full-time AF mode is set and the full-time AF operation is performed, the sampling pitch is increased from 3Fδ to 6Fδ. As a result, the easy-to-operate image-capturing apparatus having the full-time AF function of continuously properly achieving focus on a subject which moves fast or the like can be provided.

Further, in the case where both the panning state and the subject moving state are not detected after detection of the panning state by the panning/subject moving state detector 130, the AF operation performed at a small sampling pitch of 3Fδ is performed. When only the subject moving state is detected by the panning/subject moving state detector 130, the AF operation performed at a large sampling pitch is performed. Therefore, in the case where the movement of the subject is small, deviation of the focus position does not easily occur. Consequently, by shortening the sampling pitch, precision of realizing the in-focus state is assured and a live view image displayed on the liquid crystal display 16 can be prevented from being blurred. On the other hand, when the movement of the subject is large, a deviation from a proper focus position easily occurs and it becomes difficult to find the focus position. Consequently, a live view image displayed on the liquid crystal display 16 becomes slightly blurred. However, by increasing the sampling pitch, the focus position can be determined promptly and more reliably. That is, the in-focus state can be achieved on the main subject with reliability.

Modifications

Although the embodiment of the present invention has been described above, the present invention is not limited to the above description.

For example, in the foregoing embodiment, in the case where only the subject moving state is detected by the panning/subject moving state detector 130 when the full-time AF mode is set and the full-time AF operation is performed, the sampling pitch is increased from 3Fδ to 6Fδ. The present invention is not limited to the case. For example, the driving width of the imaging lens 11 may be widened to increase the number of sampling positions without changing the sampling pitch from 3Fδ.

FIG. 11 is a schematic diagram showing a curve CL5 indicating the relation between the evaluation value C obtained when the drive width of the imaging lens 11 is set to 12Fδ on both the forward and backward in the optical axis direction of the imaging lens 11 without changing the sampling pitch from 3Fδ and the position of the imaging lens 11. FIG. 11 shows an example in which the imaging lens 11 is driven forward and backward in the optical axis direction around the focus position x1 as a center, which is obtained by the one-shot AF operation at the early stage of the full-time AF operation. Blank circles shown in FIG. 11 indicate sampling positions of the image acquiring part 151 during the period since the focus position of last time is determined by the focus position determining part 154 until the next focus position is determined, and the evaluation values C calculated by the evaluation value calculator 152 on the basis of image data acquired by the image acquiring part 151. The curve CL5 is a curve obtained by performing curve approximation on the basis of the evaluation values C in the sampling positions shown by the blank circles in a manner similar to FIG. 9.

When the subject moving state is detected, as shown by the curve CL2 in FIG. 9, the curve of the evaluation values C tends to fluctuate. Consequently, for example, as shown in FIG. 11, the image acquiring part 151 acquires image data in total nine positions of the focus position x1, four positions before the focus position x1 and four position after the focus position x1 so that the sampling pitch becomes 3Fδ on the forward and backward of the focus position x1 as a center in the optical axis direction. By increasing the number of sampling positions to nine by widening the driving width of the imaging lens 11 without increasing the sampling pitch of 3Fδ, the influence of the fluctuation in the evaluation values C can be reduced so as to be relatively small. Since the evaluation values C in the nine sampling positions are largely different from each other, the evaluation values C which are largely different from each other can be also obtained.

On the other hand, in the case, as compared with the AF operation performed at a large sampling pitch, the number of sampling positions increases in the same drive range of the imaging lens 11. Accordingly, longer time is required for acquisition of image data until the next focus position is determined and for a data process until the next focus position is determined. However, by shortening the sampling pitch to 3Fδ, there is a tendency that the lens position X at the maximum value in the curve CL5 obtained by curve approximation based on the evaluation values C becomes closer to the proper focus position as compared with the AF operation performed at a large sampling pitch. That is, the in-focus state can be brought close to the proper focus on the main subject.

In other words, in this case, when the full-time AF mode is set and the full-time AF operation is performed, under control of the camera controller 100, the number of a plurality of images used at the time of determining an in-focus state of the imaging lens 11 by the focus position determining part 154 on the basis of detection of only the subject moving state by the panning/subject moving state detector 130 is increased from five to nine. The series of operations including calculation of the evaluation value C on the in-focus state of the imaging lens 11 with respect to AF evaluation areas provided in each of the plurality of images, determination of a focus position of the imaging lens 11 on the basis of the plurality of evaluation values C, and driving to the focus position of the imaging lens 11 by the driving controller 153 is repeatedly executed. As a result, the easy-to-operate image-capturing apparatus having the full-time AF function of continuously properly and more accurately achieving focus on a subject while dealing with movement of the camera, movement of the subject, and the like can be provided.

In the foregoing embodiment, in the full-time AF operation, before the shutter start button 8 is touched and the S1 state is set, the series of operations including calculation of the evaluation values on a plurality of images obtained while driving the imaging lens 11 backward and forward in the optical axis direction, determination of a focus position of the imaging lens 11 based on the plurality of evaluation values C, and driving of the imaging lens 11 to the determined focus position is repeatedly executed. However, the present invention is not limited to the above. A series of operations similar to the above may be repeatedly executed until the shutter start button 8 is depressed and the S2 state is set. After the shutter start button 8 is touched and the S1 state is set, a series of operations similar to the above may be repeatedly executed.

In the foregoing embodiment, in the case where the subject moving state is detected by the panning/subject moving state detector 130 when the full-time AF mode is set and the full-time AF operation is executed, the AF evaluation area is enlarged in the direction substantially perpendicular to the ground line. The present invention however is not limited to the direction. When the subject is a vehicle which is long in width or the like, the AF evaluation area may be enlarged in the direction substantially horizontal to the ground line.

In the foregoing embodiment, according to detection of the panning state by the panning/subject moving state detector 130, the full-time AF operation is changed. The present invention is not limited to the above. It is also possible to detect a state where the optical axis direction of the imaging lens 11 of the image-capturing apparatus 1 is moved largely in the vertical direction by the user (tilting state) and change the full-time AF operation in accordance with the tilting state by regarding the detection of the tilting state as detection of the panning state.

Although the full-time AF operation performed before capturing a still image has been described in the embodiment, the present invention is not limited to the above. For example, the full-time AF operation can be performed continuously at the time of capturing a moving image.

Although the start of image-capturing operation is instructed by depression of the shutter start button 8 in the foregoing embodiment, the present invention is not limited to the case. The start of the image-capturing operation may be instructed at a set time of a timer or the like.

While the invention has been shown and described in detail, the foregoing description is in all aspects illustrative and not restrictive. It is therefore understood that numerous modifications and variations can be devised without departing from the scope of the invention.

What is claimed is:

1. An image-capturing apparatus comprising:
an image sensor for capturing an image through a lens and generating image data;
a display for sequentially displaying a plurality of objective images based on a plurality of objective image data generated by said image sensor;
a calculator for calculating an evaluation value of each objective image data as a function of evaluation image data corresponding to a predetermined area defined on each objective image;
a driver for driving said lens to a focus position on the basis of a plurality of evaluation values calculated by said calculator;
a moving body detector for detecting whether a subject is a moving body or not on the basis of image data generated for displaying an image of said subject on said display; and
a controller, when said moving body detector detects that the subject is a moving body, for performing control of said image-capturing apparatus so as to change the size of said predetermined area and to repeatedly enable said calculator and driver.

2. The image-capturing apparatus according to claim 1, wherein
when said moving body detector detects that the subject is a moving body, said controller controls so as to enlarge said predetermined area.

3. The image-capturing apparatus according to claim 2, wherein
when said moving body detector detects that the subject is a moving body, said controller controls said image-capturing apparatus so as to enlarge said predetermined area in a direction substantially perpendicular to the ground line determined in each objective image.

4. The image-capturing apparatus according to claim 2, further comprising:
an image-capturing state detector for detecting an image-capturing state of said image-capturing apparatus, wherein
said controller controls said image-capturing apparatus so as to change the direction of enlarging said predetermined area in response to a detection result of said image-capturing state detector.

5. The image-capturing apparatus according to claim 1, further comprising:
an instruction element for instructing start of an image-capturing operation in said image-capturing apparatus, wherein
said controller controls said image-capturing apparatus so as to stop driving of said lens in response to an instruction of starting said image-capturing operation with said instruction element.

6. The image-capturing apparatus according to claim 1, wherein
said moving body detector further detects whether the image-capturing direction of said image-capturing apparatus has changed by a predetermined amount or more, and
when said moving body detector detects that said image-capturing direction has changed by said predetermined amount or more, said controller controls said image-capturing apparatus so as to inhibit the operations of said calculator and driver.

7. The image-capturing apparatus according to claim 1, further comprising:
an instruction element for instructing start of an image-capturing operation in said image-capturing apparatus, wherein
said controller controls said image-capturing apparatus so as to repeatedly enable said calculator and driver before said instruction of start of an image-capturing operation with said instruction element and to disable said calculator and driver in response to said instruction of start of the image-capturing operation with said instruction element.

8. The image-capturing apparatus according to claim 1, wherein
said evaluation value includes a value regarding image contrast obtained from corresponding objective image data.

9. An image-capturing apparatus comprising:
an image sensor for capturing an image through a lens and generating image data;
a display for sequentially displaying a plurality of objective images based on a plurality of objective image data generated by said image sensor;
a calculator for calculating an evaluation value of each objective image data as a function of evaluation image data corresponding to a predetermined area defined on each objective image;
a driver for driving said lens to a focus position on the basis of a plurality of evaluation values calculated by said calculator;
a moving body detector for detecting whether a subject is a moving body or not on the basis of image data generated for displaying an image of said subject on said display; and
a controller, when said moving body detector detects that the subject is a moving body, for performing control of said image-capturing apparatus so as to change a distance of movement of said lens by said driver and to repeatedly enable said calculator and driver.

10. The image-capturing apparatus according to claim 9, wherein
when said moving body detector detects that a subject is a moving body, said controller controls so as to increase the distance of movement of said lens.

11. The image-capturing apparatus according to claim 9, further comprising:
an instruction element for instructing start of an image-capturing operation in said image-capturing apparatus, wherein
said controller controls said image-capturing apparatus so as to stop driving of said lens in response to an instruction of starting said image-capturing operation with said instruction element.

12. The image-capturing apparatus according to claim 9, wherein
said moving body detector further detects whether the image-capturing direction of said image-capturing apparatus has changed by a predetermined amount or more, and
when said moving body detector detects that said image-capturing direction has changed by said predetermined amount or more, said controller controls said image-capturing apparatus so as to inhibit the operations of said calculator and driver.

13. The image-capturing apparatus according to claim 9, wherein
said evaluation value includes a value regarding image contrast obtained from corresponding objective image data.

14. An image-capturing apparatus comprising:
an image sensor for capturing an image through a lens and generating image data;
a display for sequentially displaying a plurality of objective images based on a plurality of objective image data generated by said image sensor;
a calculator for calculating an evaluation value of each objective image data as a function of evaluation image data corresponding to a predetermined area defined on each objective image;
a driver for driving said lens to a focus position on the basis of a plurality of evaluation values calculated by said calculator;
a moving body detector for detecting whether a subject is a moving body or not on the basis of image data generated for displaying an image of said subject on said display; and
a controller, when said moving body detector detects that the subject is a moving body, for performing control of said image-capturing apparatus so as to change the number of said plurality of evaluation values and to repeatedly enable said calculator and driver.

15. The image-capturing apparatus according to claim 14, wherein
when said moving body detector detects that a subject is a moving body, said controller controls so as to increase the number of said plurality of evaluation values.

16. The image-capturing apparatus according to claim 14, further comprising:
an instruction element for instructing start of an image-capturing operation in said image-capturing apparatus, wherein
said controller controls said image-capturing apparatus so as to stop driving of said lens in response to an instruction of starting said image-capturing operation with said instruction element.

17. The image-capturing apparatus according to claim 14, wherein
said moving body detector further detects whether the image-capturing direction of said image-capturing apparatus has changed by a predetermined amount or more, and
when said moving body detector detects that said image-capturing direction has changed by said predetermined amount or more, said controller controls said image-capturing apparatus so as to inhibit the operations of said calculator and driver.

18. The image-capturing apparatus according to claim 14, wherein
said evaluation value includes a value regarding image contrast obtained from corresponding objective image data.
